(19) United States
(12) Patent Application Publication
(10) Pub. No.: US 2006/0057864 A1
(43) Pub. Date: Mar. 16, 2006

(54) Rotative electrical coupling

(76) Inventor: Jeffrey A. Joseph, Hummelstown, PA (US)

Correspondence Address: RATNERPRESTIA, P O BOX 980, VALLEY FORGE, PA, 19482-0980, US

(21) Appl. No.: 10/939,584

(22) Filed: Sep. 13, 2004

(51) Int. Cl. H01R 39/00

(52) U.S. Cl. 439/24

(57) ABSTRACT

A rotative electrical coupling for providing electrical interconnection between a stationary component and a rotating component. The rotating component rotates with respect to the stationary component. The rotative electrical coupling includes a first conductive plate configured to be in electrical contact with a conductor of the stationary component and a second conductive plate configured to be in electrical contact with a conductor of the rotating component. The second conductive plate is in constant electrical contact with the first conductive plate, and the second conductive plate rotates with respect to the first conductive plate during rotation of the rotating component with respect to the stationary component. The first conductive plate and the second conductive plate are formed of dissimilar metals.

### FIELD OF THE INVENTION

The present invention relates generally to rotative electrical couplings and, more particularly, to rotative electrical couplings including conductive plates for transferring electrical signals between the plates.

### BACKGROUND OF THE INVENTION

Electrical slip rings are often used to provide the signal transmission path when transmitting electrical signals (e.g., power signals, communication signals, and the like) between a stationary structure and a rotating structure (i.e., a structure that rotates with respect to the stationary structure). An electrical slip ring is an electromechanical device also known as a rotary electrical joint. Slip rings typically include conductive brushes that contact conductive bands to pass electrical current from the stationary structure to the rotating structure.

Current electrical slip ring technology suffers from a number of deficiencies. For example, the conductive brushes of the electrical slip ring tend to “wear” unevenly resulting in poor electrical contact. Further, in certain applications, because only a portion of the rotative range of the electrical slip ring is used in operation, the corresponding remaining portion of the conductive band may become oxidized or corroded; such a condition causes the ring to have high electrical resistance and poor communication characteristics. Further still, material and size constraints in conventional electrical slip rings restrict to relatively small the electrical contact surface area between a conductive brush and a corresponding conductive band.

Thus, it would be desirable to provide a rotative electrical coupling that overcomes one or more of the deficiencies described above. An improved rotative electrical coupling has been manufactured by the assignee, Hydromotion Inc., of the present application. This rotative electrical coupling is an hermetically sealed unit that is filled with a silicone liquid to protect against internal corrosion and to provide enhanced electrical properties. The present invention constitutes a further improvement relative to conventional devices known in the art.

### SUMMARY OF THE INVENTION

According to an exemplary embodiment of the present invention, a rotative electrical coupling for providing electrical interconnection between a stationary component and a rotating component is provided. The rotating component rotates with respect to the stationary component. The rotative electrical coupling includes a first conductive plate configured to be in electrical contact with a conductor of the stationary component and a second conductive plate configured to be in electrical contact with a conductor of the rotating component. The second conductive plate is in constant electrical contact with the first conductive plate, and the second conductive plate rotates with respect to the first conductive plate during rotation of the rotating component with respect to the stationary component. The first conductive plate and the second conductive plate are formed of dissimilar metals.

According to another exemplary embodiment of the present invention, a rotative electrical coupling for providing electrical interconnection between a stationary component and a rotating component is provided. The rotating component rotates with respect to the stationary component. The rotative electrical coupling includes a base and a plurality of pairs of conductive plates. Each of the pairs includes a first conductive plate configured to be in electrical contact with a conductor of the stationary component and a second conductive plate configured to be in electrical contact with a conductor of the rotating component. The second conductive plate is in constant electrical contact with the first conductive plate, and the second conductive plate rotates with respect to the first conductive plate during rotation of the rotating component with respect to the stationary component. The first conductive plate and the second conductive plate are formed of dissimilar metals.

The rotative electrical coupling also includes a plurality of insulators. At least one of the plurality of insulators is provided between each of the pairs such that each of the pairs is insulated from the other pairs and configured to carry a distinct electrical signal. The rotative electrical coupling also includes a housing configured to be coupled to the base such that the plurality of pairs of conductive plates and the plurality of insulators are disposed substantially between the housing and the base.

It is to be understood that both the foregoing general description and the following detailed description are exemplary, but are not restrictive, of the invention.

### BRIEF DESCRIPTION OF THE DRAWING

The invention is best understood from the following detailed description when read in connection with the accompanying drawing. It is emphasized that, according to common practice, the various features of the drawing are not to scale. On the contrary, the dimensions of the various features are arbitrarily expanded or reduced for clarity. Included in the drawing are the following figures:

FIG. 1 is a sectional view of a rotative electrical coupling in accordance with an exemplary embodiment of the present invention;

FIG. 2 is top perspective view of a portion of the rotative electrical coupling of FIG. 1 highlighting the base;

FIG. 3 is a top perspective view of a portion of the rotative electrical coupling of FIG. 1 highlighting the engagement of studs with the base;

FIG. 4 is a top perspective view of a portion of the rotative electrical coupling of FIG. 1 highlighting a base bearing;

FIG. 5 is a top perspective view of a portion of the rotative electrical coupling of FIG. 1 highlighting the engagement of insulator tubes with the studs;

FIG. 6 is a top perspective view of a portion of the rotative electrical coupling of FIG. 1 highlighting a base ring seal;

FIG. 7 is a top perspective view of a portion of the rotative electrical coupling of FIG. 1 highlighting a spacer;

FIG. 8 is a top perspective view of a portion of the rotative electrical coupling of FIG. 1 highlighting a contact plate insulator;

FIG. 9 is a top perspective view of a portion of the rotative electrical coupling of FIG. 1 highlighting an inner contact plate;

FIG. 10 is a top perspective view of a portion of the rotative electrical coupling of FIG. 1 highlighting an outer contact plate;

FIG. 11 is a top perspective view of a portion of the rotative electrical coupling of FIG. 1 highlighting another contact plate insulator;

FIG. 12 is a top perspective view of a portion of the rotative electrical coupling of FIG. 1 highlighting another outer contact plate;

FIG. 13 is a top perspective view of a portion of the rotative electrical coupling of FIG. 1 highlighting another inner contact plate;

FIG. 14 is a top perspective view of a portion of the rotative electrical coupling of FIG. 1 highlighting another contact plate insulator;

FIG. 15 is a top perspective view of a portion of the rotative electrical coupling of FIG. 1 highlighting yet another contact plate insulator;

FIG. 16 is a top perspective view of a portion of the rotative electrical coupling of FIG. 1 highlighting a plurality of inner contact plates, outer contact plates, and contact plate insulators;

FIG. 17 is a top perspective view of a portion of the rotative electrical coupling of FIG. 1 highlighting a contact plate wave spring;

FIG. 18 is a top perspective view of a portion of the rotative electrical coupling of FIG. 1 highlighting a top portion;

FIG. 19 is a top perspective view of a portion of the rotative electrical coupling of FIG. 1 highlighting engagement of nuts, washers, and studs;

FIG. 20A is a top perspective view of a portion of the rotative electrical coupling of FIG. 1 highlighting a housing;

FIG. 20B is a view of FIG. 20A with the top portion and the housing partially removed;

FIG. 21 is a top perspective view of a portion of the rotative electrical coupling of FIG. 1 highlighting a top ring seal;

FIG. 22 is a top perspective view of a portion of the rotative electrical coupling of FIG. 1 highlighting a top thrust bearing;

FIG. 23 is a top perspective view of a portion of the rotative electrical coupling of FIG. 1 highlighting a top thrust washer;

FIG. 24 is a top perspective view of a portion of the rotative electrical coupling of FIG. 1 highlighting a top wave ring;

FIG. 25 is a perspective view of a portion of the rotative electrical coupling of FIG. 1 highlighting a housing wire spacer;

FIG. 26 is a perspective view of the rotative electrical coupling of FIG. 1 highlighting a base seal;

FIG. 27 is a partial cutaway perspective view of a rotative electrical coupling in accordance with an exemplary embodiment of the present invention;

FIG. 28 is a cutaway perspective view of a rotative electrical coupling in accordance with an exemplary embodiment of the present invention;

FIG. 29 is an internal perspective view of a portion of a rotative electrical coupling in accordance with an exemplary embodiment of the present invention;

FIG. 30 is an exploded perspective view of a set of contact plates and contact plate insulators in accordance with an exemplary embodiment of the present invention; and

FIG. 31 is a non-exploded perspective view of the set of contact plates and contact plate insulators of FIG. 30.

### DETAILED DESCRIPTION OF THE INVENTION

The present invention relates to a rotative electrical coupling configured to provide electrical interconnection between a stationary component (e.g., a stationary structure) and a rotating component (e.g., a rotating structure), where the rotating component rotates with respect to the stationary component. In certain applications, the stationary component may also be rotatively moved with respect to the rotating component and, therefore, the terms “stationary component” and “rotating component” (and the terms “stationary structure” and “rotating structure”) are simply used to illustrate that at least one of the components may be moved about a rotational axis with respect to the other component.

According to certain exemplary embodiments of the present invention, the electrical interconnection between a stationary structure and a rotative structure is provided via one or more pairs of contact plates (i.e., conductive plates). Each of the contact plates in a pair is in constant electrical contact with the other. Further, each of the contact plates in a pair moves about an axis with a respective one of the stationary structure and the rotative structure. For example, a first conductor may extend from the stationary structure to a first of the contact plates in a pair. Likewise, a second conductor may extend from the rotative structure to a second of the contact plates in the pair. Thus, an electrical signal may be transmitted from the stationary structure to the rotative structure (or vice versa) through a signal path including the first conductor, the first contact plate, the second contact plate, and the second conductor.

As used in this document, the terms “conductive plates” and “contact plates” are interchangeable. Further, the term “plates” is intended to refer to a number of configurations including solid plates, solid plates having a small aperture, and ring-shaped plates. In the accompanying figures, the conductive plates (i.e., the contact plates) are ring-shaped, but they are not limited to that shape.

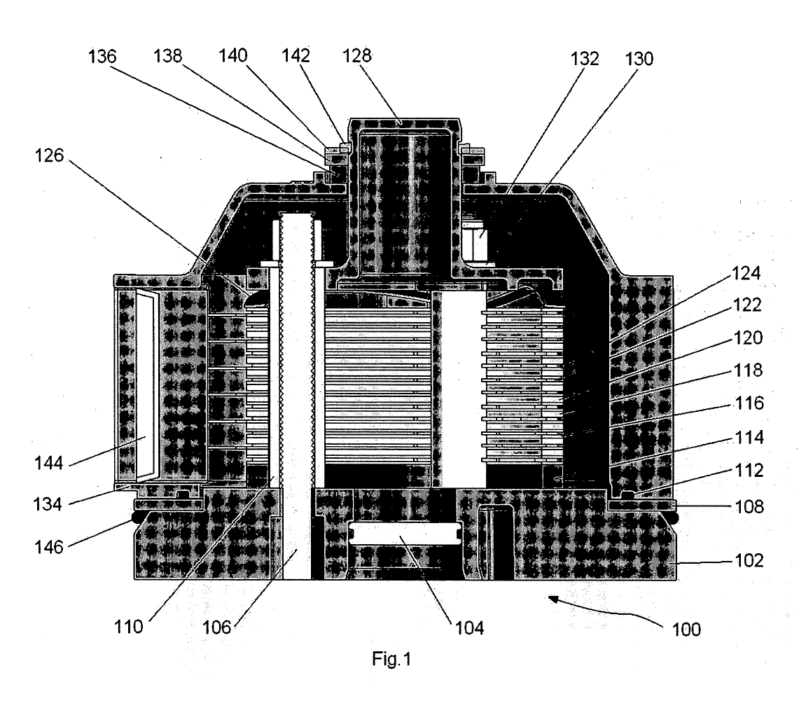

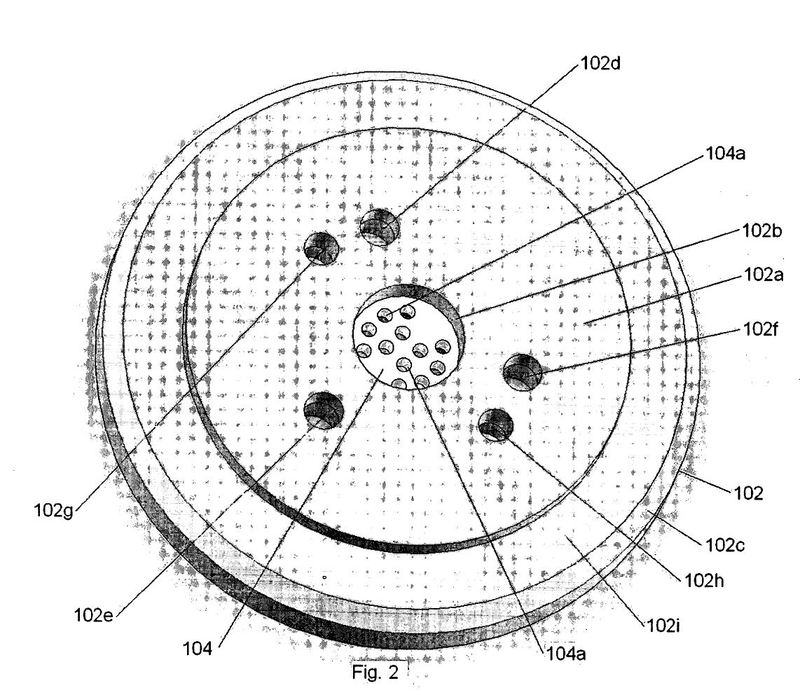

Referring now to the figures, in which like reference numbers refer to like elements throughout the various figures that comprise the drawing, FIG. 1 is a sectional view of rotative electrical coupling 100. As detailed below, a number of components of rotative electrical coupling 100 are labeled on FIG. 1. Details regarding the structure and function of certain of these components are described, however, in greater detail by reference to FIGS. 2-31.

As shown in FIG. 1, rotative electrical coupling 100 includes base wire spacer 104 which is inserted into an aperture defined by base 102. Studs 106 (only one stud 106 is visible in FIG. 1) are engaged in the apertures (e.g., threaded apertures) defined by base 102. Base bearing 108 is disposed on a surface of base 102. An insulator tube 110 is provided over at least a portion of each of studs 106. Base ring seal 112 is disposed on base bearing 108. Spacer 114 is disposed on another surface of base 102.

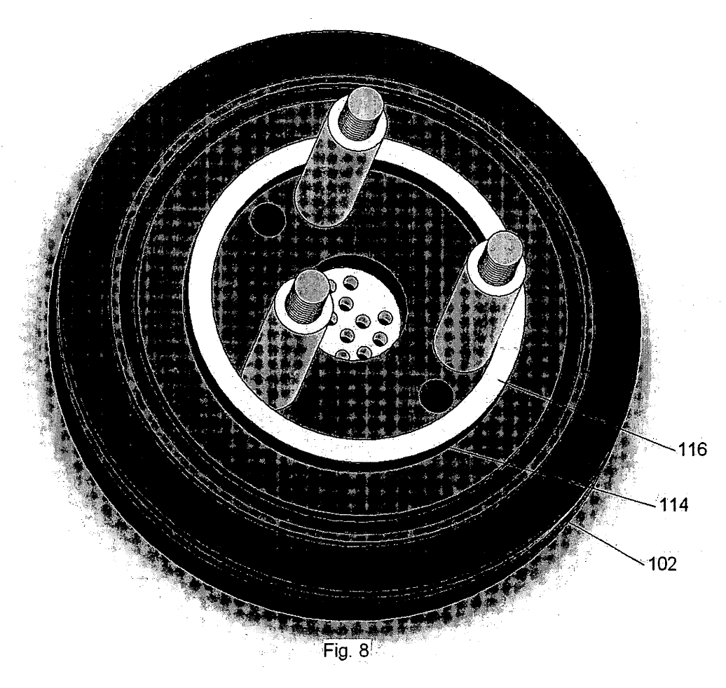

A plurality of contact plate insulators 116, contact plate insulators 118, contact plate insulators 120, inner contact plates 122, and outer contact plates 124 are arranged in a “stacked” configuration within rotative electrical coupling 100. The stacked arrangement of contact plate insulators 116, contact plate insulators 118, contact plate insulators 120, inner contact plates 122, and outer contact plates 124 is described in greater detail with respect to FIGS. 8-17. According to the exemplary embodiment of the present invention illustrated in FIG. 1, the stacked arrangement includes seven contact plate insulators 116, five contact plate insulators 118, six contact plate insulators 120, twelve inner contact plates 122, and twelve outer contact plates 124.

Contact plate stack wave spring 126 is disposed on the stack of contact plates and contact plate insulators, and a top portion 128 is disposed on contact plate wave spring 126. A washer 130 and a nut 132 are engaged with each of studs 106 (only one washer 130 and one nut 132 are illustrated in FIG. 1). A housing 134 is provided to substantially enclose the internal assembly of rotative electrical coupling 100. A top ring seal 136 is disposed on a surface of housing 134, and a top thrust bearing 138 is disposed on top ring seal 136. A top thrust washer 140 is disposed on top thrust bearing 138, and a top wave ring 142 is disposed in a groove defined by top portion 128.

A housing wire spacer 144 is configured to be inserted in an aperture defined by housing 134. A base O-ring excluder seal 146 is provided as a seal between base 102 and base bearing 108.

Rotative electrical coupling 100 is used to provide electrical interconnection between a stationary structure and a rotating structure. For example, base 102 may be secured to a stationary structure, where conductors configured to carry signals to, from, or both to and from the stationary structure extend through base wire spacer 104 and connect to one or more of inner contact plates 122. Likewise, conductors carrying electrical signals to, from, or both to and from the rotating structure may extend through housing wire spacer 144 and connect to one or more of outer contact plates 124. Through the use of rotative electrical coupling 100, electrical signals are transmitted between the stationary structure and the rotative structure across pairs of inner contact plates 122 and outer contact plates 124.

A description of the assembly and construction of rotative electrical coupling 100 will now be provided by reference to FIGS. 2-31. The steps involved in assembling rotative electrical coupling 100 are not necessarily limited, however, to the order presented in this document, by way of example, with respect to FIGS. 2-31.

FIG. 2 illustrates base 102 which may be constructed, for example, of a polymeric material such as molded plastic. Base 102 includes an upper surface 102a which defines apertures 102b, 102d, 102e, 102f, 102g, and 102h. A lower surface 102i of base 102 extends from an outer edge of upper surface 102a to a beveled edge 102c. Base wire spacer 104 (which has a number of apertures 104a through it) is engaged in aperture 102b. Although not illustrated in FIG. 2, a seal (e.g., an O-ring) may be disposed between base wire spacer 104 and aperture 102b. For example, such a seal may be circular in shape, encircle an outer edge of base wire spacer 104, and contact the surface of base 102 defining aperture 102b.

Electrical signal carrying conductors (not illustrated in FIG. 2) may extend from below base 102 (e.g., from a structure on which base 102 is mounted) through apertures 104a defined by base wire spacer 104, thereby entering an internal region of rotative electrical coupling 100. Such conductors may be electrically coupled to one or more inner contact plates 122, as detailed below. After the desired conductors have been extended through base wire spacer 104, any openings in base wire spacer 104 (including any gaps between a conductor and a respective aperture 104a and any apertures 104a that remain open) may be sealed using a compound such as, for example, RTV sealant (i.e., room temperature vulcanizer sealant).

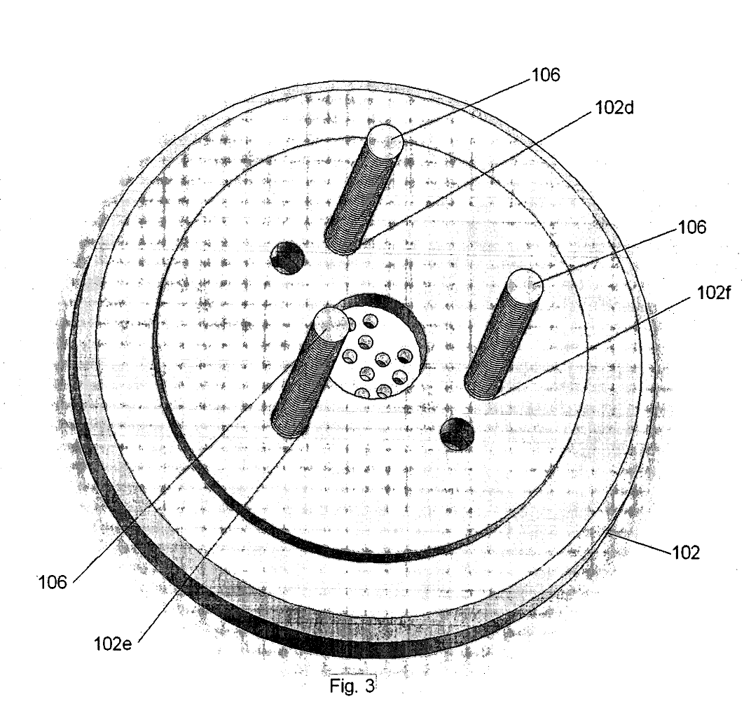

FIG. 3 illustrates a stud 106 engaged with each of apertures 102d, 102e, and 102f. For example, apertures 102d, 102e, and 102f may be threaded to receive studs 106. Alternatively, threaded inserts (not shown in FIG. 3) may be provided in each of apertures 102d, 102e, and 102f to receive studs 106. Prior to the engagement of studs 106 with apertures 102d, 102e, and 102f, an anaerobic sealant (e.g., LockTite® material available from Henkel) may be applied to the end of studs 106 or to apertures 102d, 102e, and 102f (or to both), such that studs 106 will remain substantially fixed in place after the assembly of rotative electrical coupling 100 is complete.

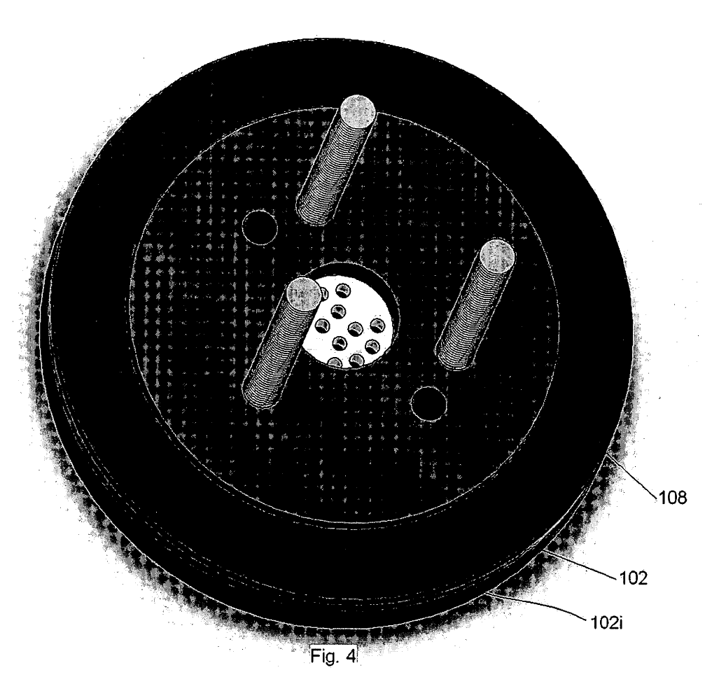

FIG. 4 illustrates base bearing 108 disposed on lower surface 102i of base 102. Base bearing 108 may be constructed of a material such as, for example, polytetrafluoroethylene. A suitable polytetrafluoroethylene is sold under the trademark Teflon® by E.I. duPont de Nemours & Co., Inc. of Wilmington, Del. Prior to disposing base bearing 108 on lower surface 102i, a thin coating of a suitable grease may be applied to lower surface 102i. Facilitated by the use of base bearing 108, housing 134 (not shown in FIG. 4) may rotate with respect to base 102.

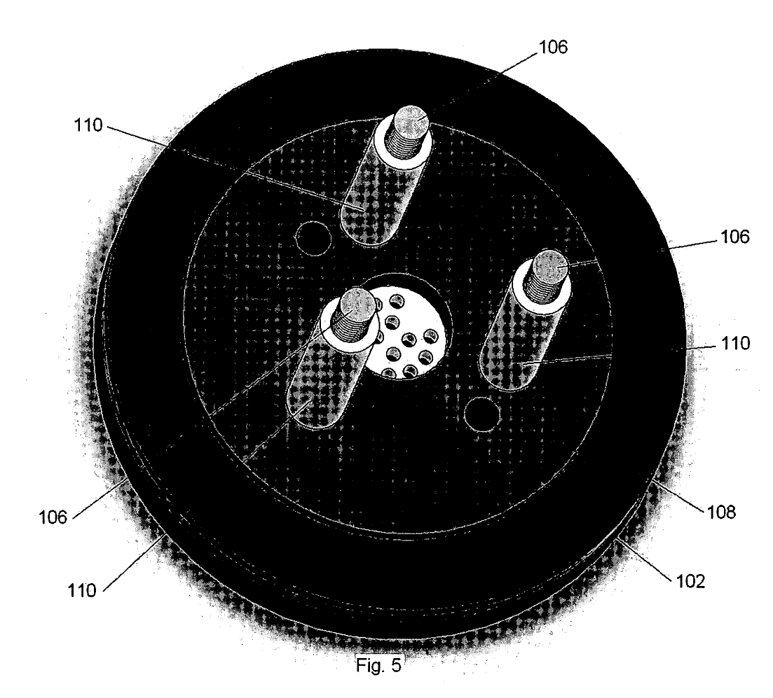

FIG. 5 illustrates insulator tubes 110 covering a substantial length of studs 106. Insulator tubes 110 may be constructed of any of a number of suitable insulative materials, such as, for example, acetal. Insulator tubes 110 are provided to insulate the conductive contact plates (i.e., inner contact plates 122 and outer contact plates 124) from studs 106.

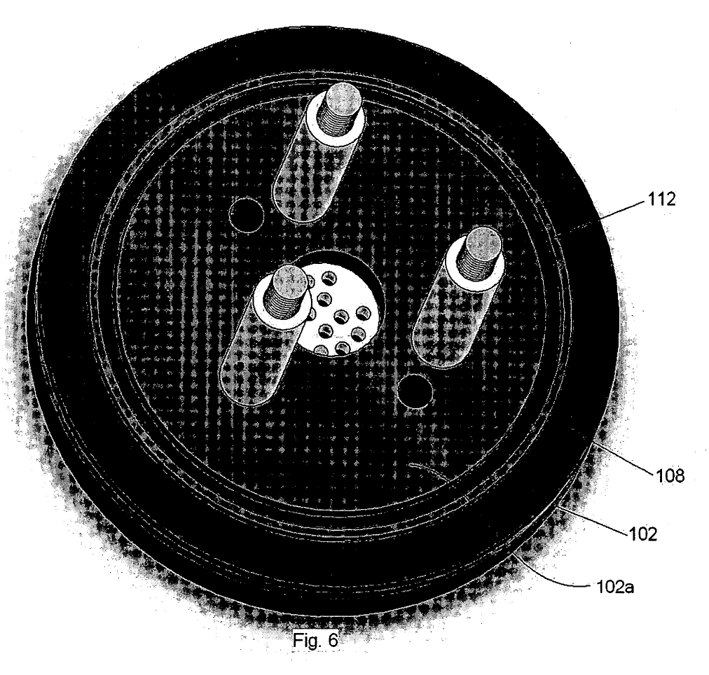

FIG. 6 illustrates base ring seal 112 disposed on bearing 108. In fact, base ring seal 112 may desirably be inserted into a groove defined in the bottom of housing 134 (not illustrated in FIG. 6) as opposed to being directly disposed on bearing 108 as illustrated in FIG. 6. In such a case, after being inserted into the groove defined in the bottom of housing 134, base ring seal 112 contacts bearing 108 when housing 134 is installed (see FIG. 1). Base ring seal 112 may be constructed of a rubber-based material such as, for example, nitrile. In conjunction with a number of other seals of rotative electrical coupling 100, base ring seal 112 helps to prevent moisture and other contaminants from entering the internal region of rotative electrical coupling 100.

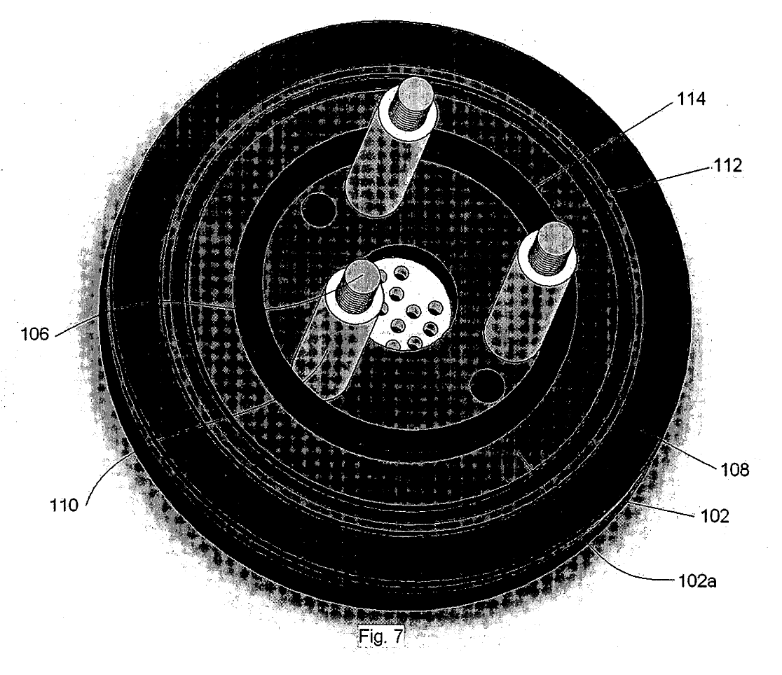

FIG. 7 illustrates spacer 114 disposed on upper surface 102a of base 102 around insulator tubes 110. Spacer 114 elevates the contact plate stack assembly, including inner contact plates 122 and outer contact plates 124 (not illustrated in FIG. 7), from upper surface 102a of base 102. Such elevation provides clearance for electrical connection to the contact plates of the contact plate stack assembly.

FIG. 8 illustrates inner contact plate insulator 116 disposed on spacer 114. Inner contact plate insulator 116 acts as a shim and as an insulator for the contact plate stack assembly.

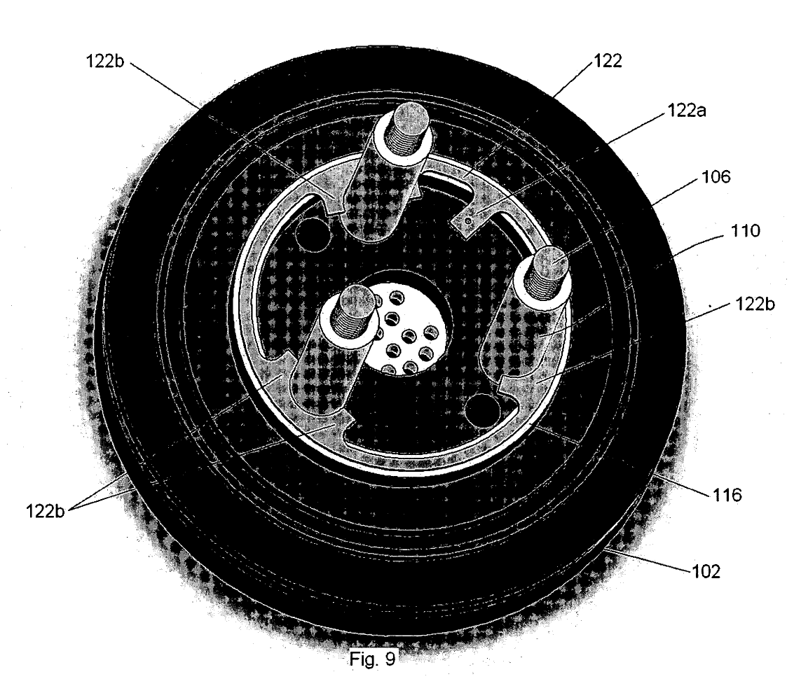

FIG. 9 illustrates inner contact plate 122 disposed on inner contact plate insulator 116. Inner contact plate 122 defines six anti-rotation tabs 122b (only four anti-rotation tabs 122b are completely visible in FIG. 9). A pair of anti-rotation tabs 122b surrounds each of insulator tubes 110. Anti-rotation tabs 122b are provided to resist rotation of inner contact plate 122 with respect to base 102.

Inner contact plate 122 also defines a conductive tab 122a (i.e., conductive male terminal 122a). At this stage of the assembly of rotative electrical coupling 100, a conductor may be extended through an aperture 104a defined by base wire spacer 104. A female terminal may be crimped onto a bare end of such a conductor, and the female terminal may then be engaged with conductive tab 122a. Alternatively, the bare portion of the conductor, without a female terminal, may be soldered to conductive tab 122a.

Inner contact plate 122 may be formed of any of a number of conductive or semi-conductive materials. According to an exemplary embodiment of the present invention, inner contact plate 122 is formed of a soft metal such as, for example, brass.

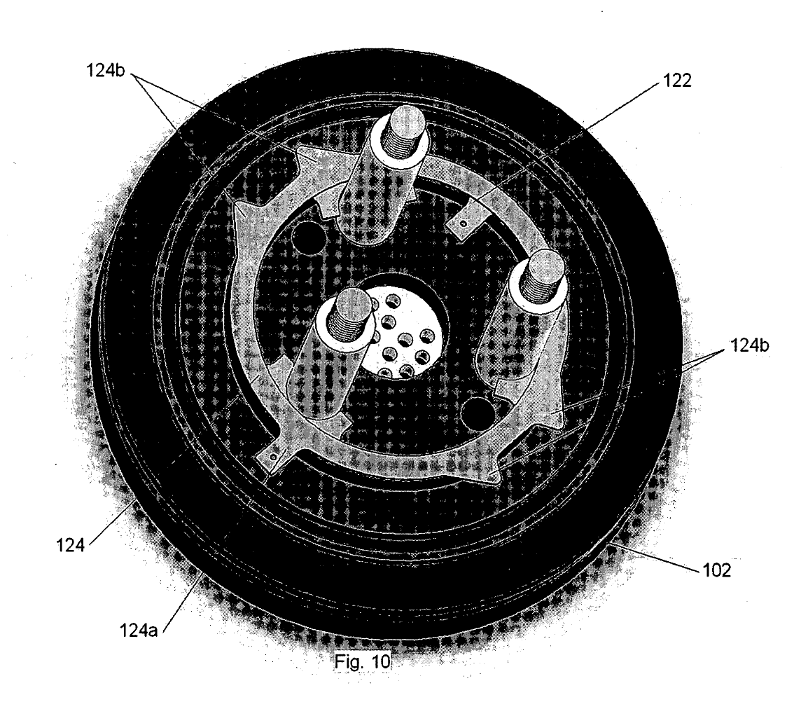

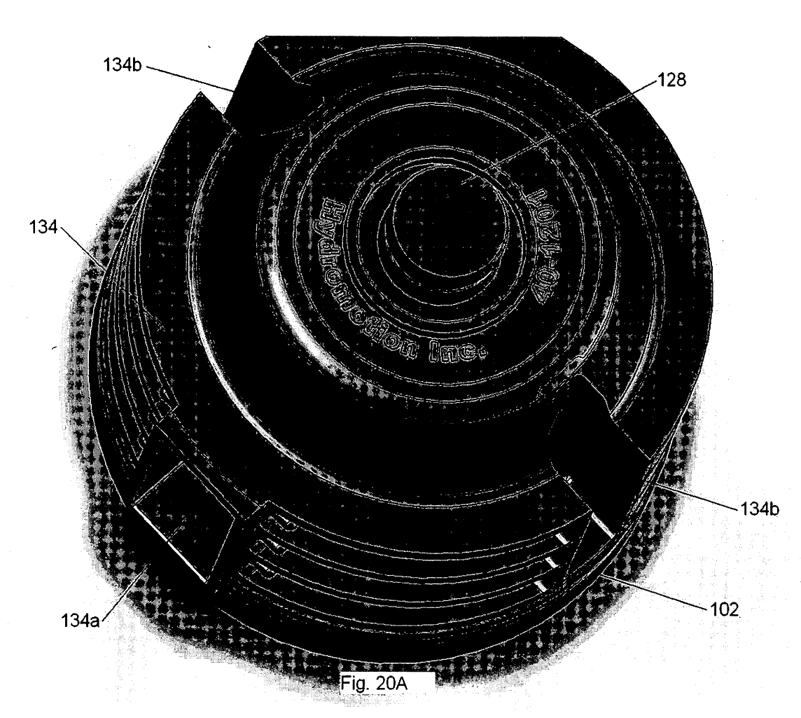

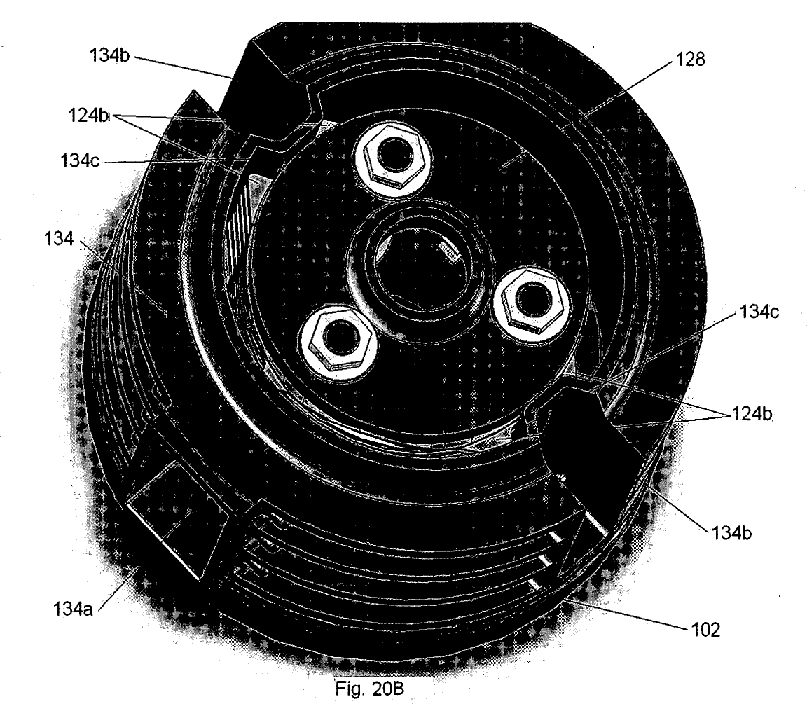

FIG. 10 illustrates outer contact plate 124 disposed on inner contact plate 122. Outer contact plate 124 defines anti-rotation tabs 124b for resisting rotation of outer contact plate 124 with respect to housing 134 (see FIG. 20B and its associated explanation). Outer contact plate 124 also defines conductive tab 124a. A dry lubricant material (not illustrated in FIG. 10) may be provided on one or both surfaces of outer contact plate 124. Thus, such a dry lubricant material may be provided between inner contact plate 122 and outer contact plate 124.

By disposing outer contact plate 124 on inner contact plate 122, inner contact plate 122 and outer connect plate 124 are in constant conductive contact during operation, even during rotation of inner contact plate 122 with respect to outer contact plate 124. Outer contact plate 124 may be formed of any of a number of conductive or semi-conductive materials. According to an exemplary embodiment of the present invention, outer contact plate 124 is formed of a hard metal such as, for example, steel.

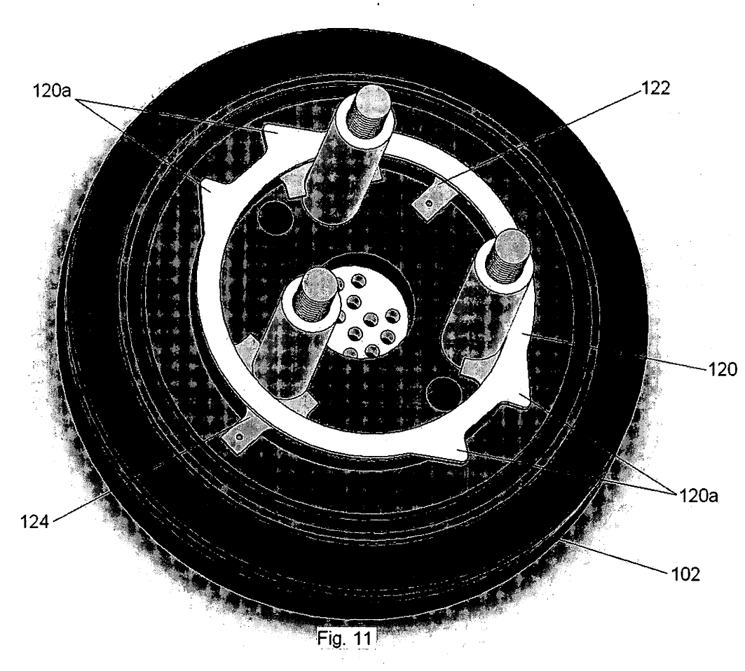

FIG. 11 illustrates outer contact plate insulator 120 disposed on outer contact plate 124. As illustrated in FIG. 11, outer contact plate insulator 120 includes anti-rotation tabs 120a for resisting rotation of outer contact plate insulator 120 with respect to housing 134 and outer contact plate 124.

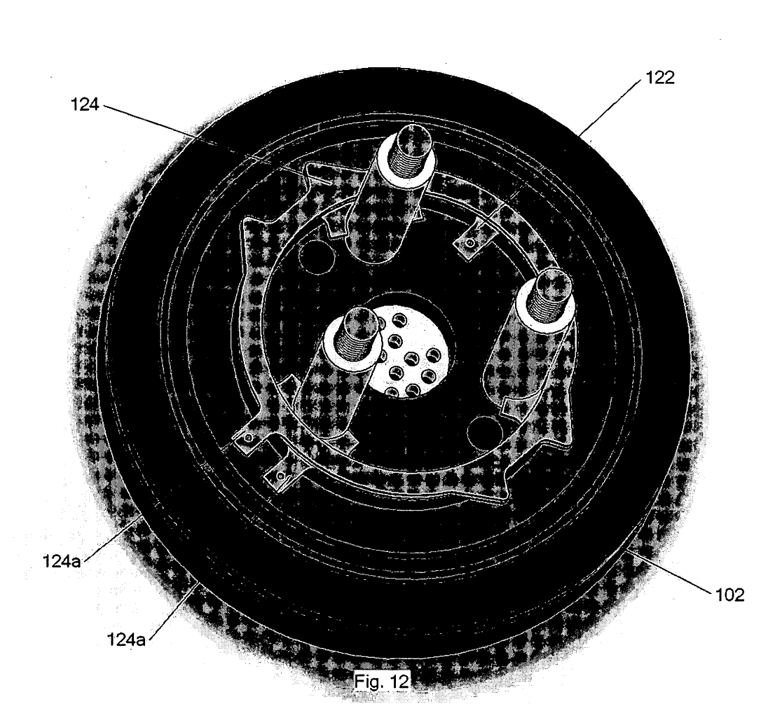

FIG. 12 illustrates another outer contact plate 124 disposed on outer contact plate insulator 120 (not shown in FIG. 12). As illustrated in FIG. 12, outer contact plate 124 disposed on the stack in FIG. 12 (the upper outer contact plate 124) includes a conductive tab 124a offset to the left with respect to the conductive tab 124a of the outer contact plate 124 disposed on the stack in FIG. 10 (the lower outer contact plate 124 of which only conductive tab 124a is visible in FIG. 12). Such an offset between conductive tabs 124a provides clearance between them to facilitate the engagement of electrical connectors to each of conductive tabs 124a.

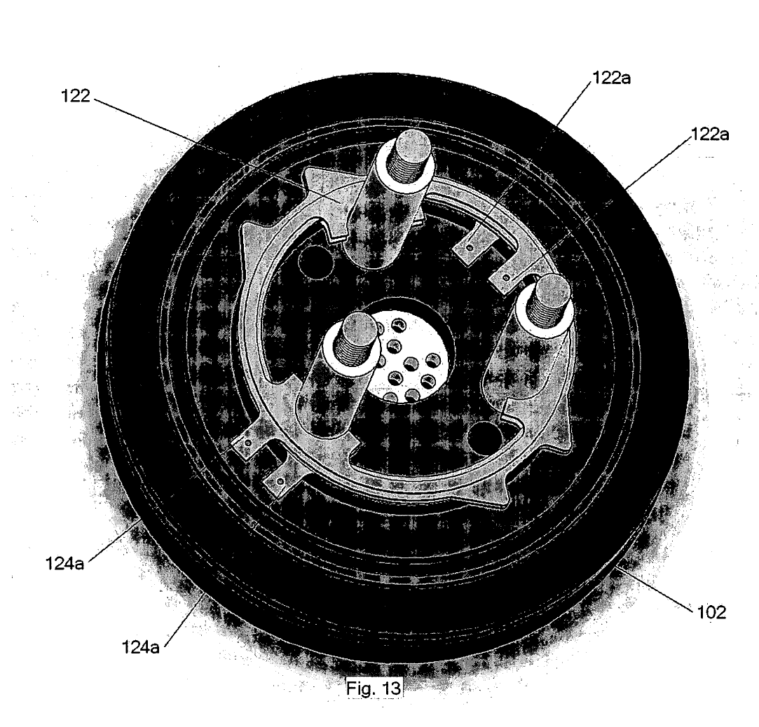

FIG. 13 illustrates another inner contact plate 122 disposed on outer contact plate 124 shown installed in FIG. 12. As illustrated in FIG. 13, conductive tabs 122a of the two installed inner contact plates 122 (i.e., inner contact plate 122 installed at FIG. 9 which is the lower inner contact plate 122, and inner contact plate 122 installed at FIG. 13 which is the upper inner contact plate 122) are offset from one another, thereby facilitating connection of electrical connectors to conductive tabs 122a. As described above with respect to FIG. 9, a conductor may be extended through an aperture 104a defined by base wire spacer 104 and electrically coupled to conductive tab 122a of inner contact plate 122 shown installed in FIG. 13. For example, such a conductor may be electrically coupled to conductive tab 122a using a female spade-type terminal or by soldering.

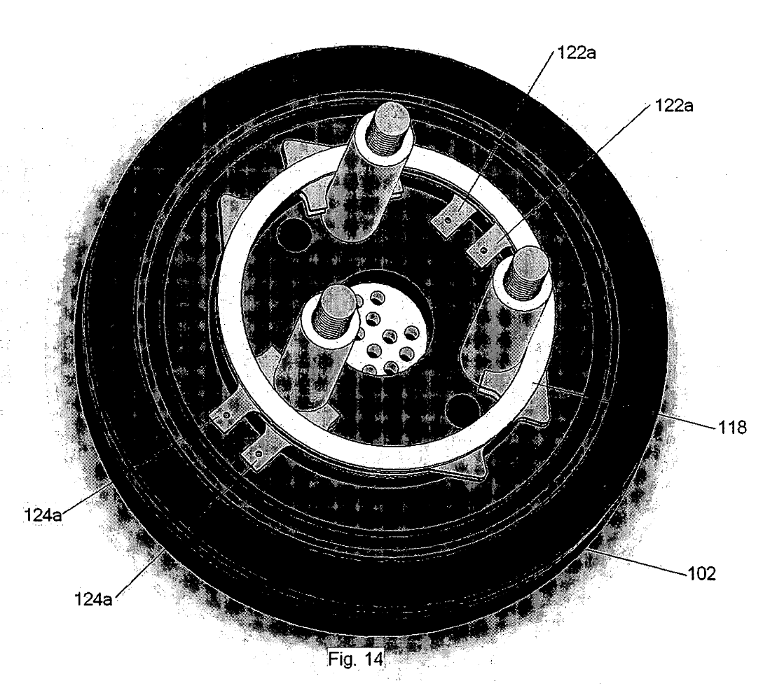

FIG. 14 illustrates inner contact plate insulator 118 disposed on inner contact plate 122 shown installed in FIG. 13.

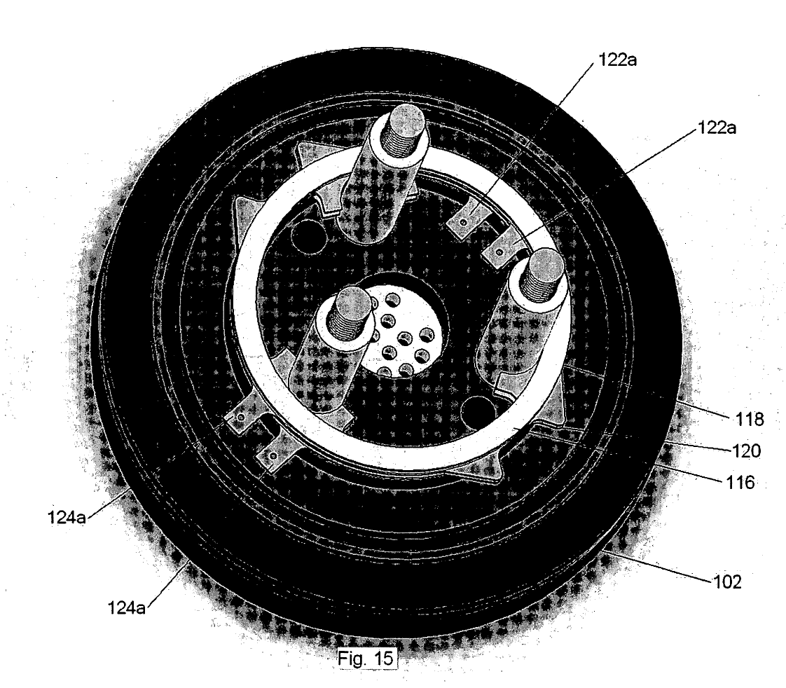

In FIG. 15, inner contact plate insulator 116 is disposed on inner contact plate insulator 118 shown installed in FIG. 14. For example, the two inner contact plate insulators 116 and 118 detailed in FIGS. 14 and 15 may be used as opposed to a single thicker inner contact plate insulator because, for example, inner contact plate insulators 116 and 118 may be readily available. Nevertheless, a single inner contact plate insulator is contemplated.

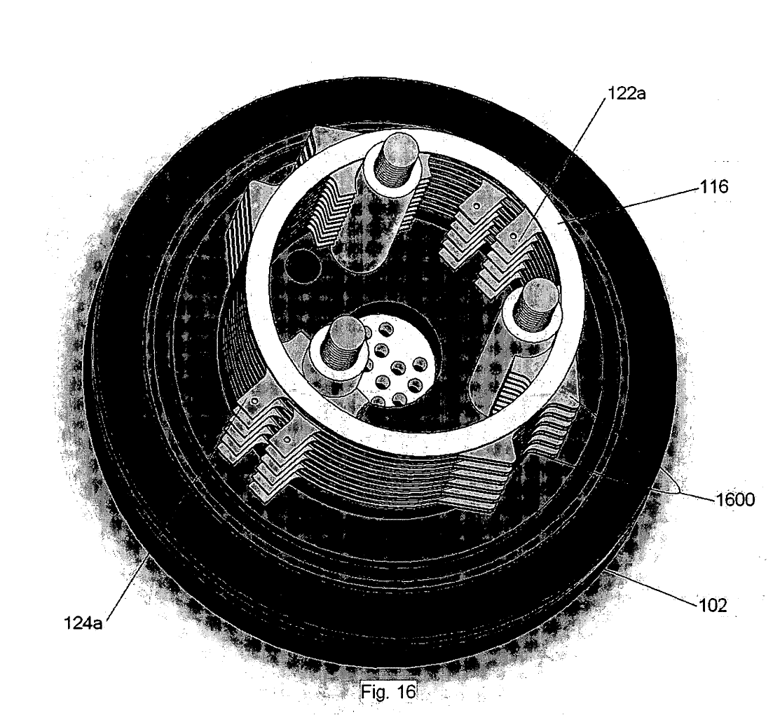

FIG. 16 illustrates a contact stack 1600 which includes a plurality of inner contact plates 122, outer contact plates 124, inner contact plate insulators 116, inner contact plate insulators 118, and outer contact plate insulators 120. As illustrated in FIG. 16, twelve pairs of inner contact plates 122 and outer contact plates 124 (i.e., twelve circuits) are provided. Each pair (including an inner contact plate 122 and an outer contact plate 124) is electrically insulated from adjacent pairs through the use of contact plate insulators. Thus, twelve discrete circuit paths are provided through rotative electrical coupling 100. Each of the twelve discrete circuit paths is accessed by electrically connecting a conductor to one of conductive tabs 122a (FIG. 16 illustrates twelve conductive tabs 122a arranged in two columns) and by connecting another conductor to a respective one of conductive tabs 124a (FIG. 16 illustrates twelve conductive tabs 124a arranged in two columns).

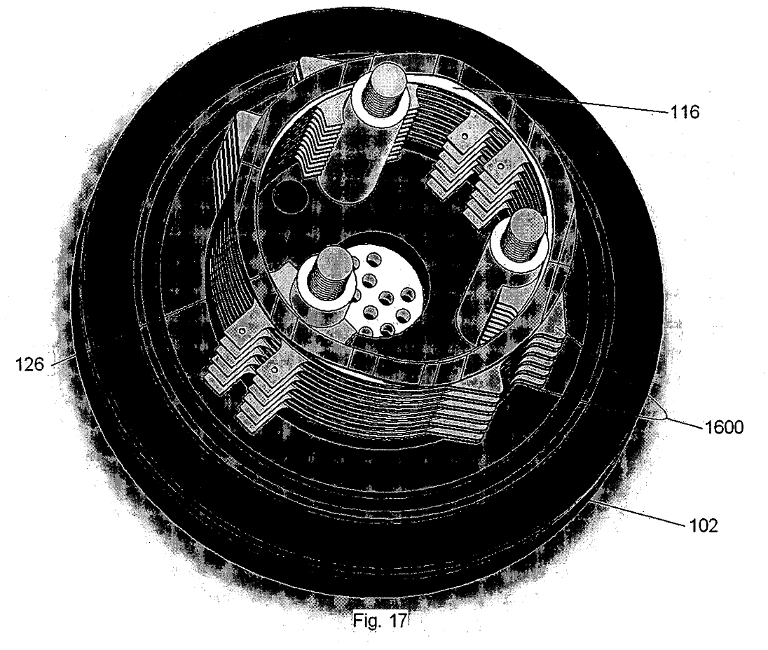

FIG. 17 illustrates contact plate stack wave spring 126 which is used to provide a desired downward compressive force on contact stack 1600 to ensure proper electrical contact between each of the pairs of contact plates (where each pair includes one inner contact plate 122 and one outer contact plate 124).

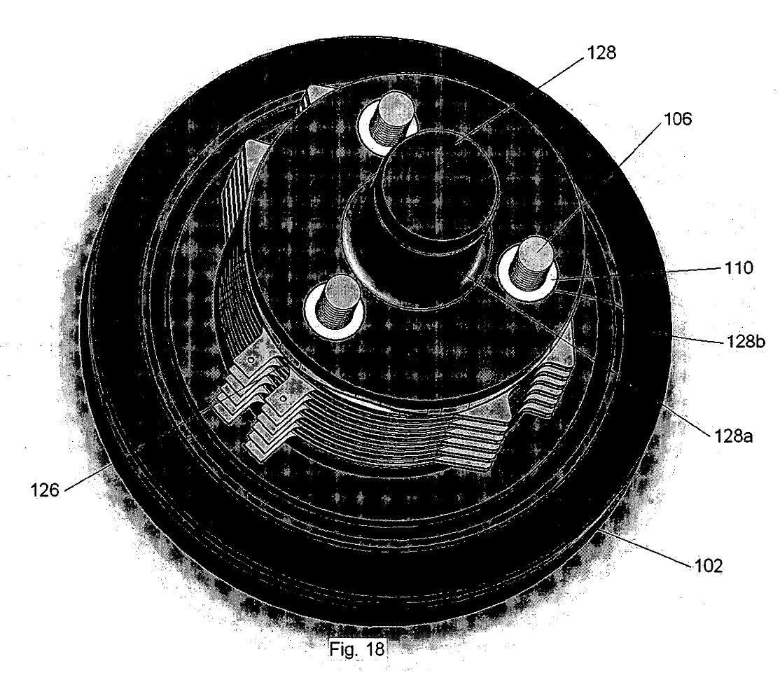

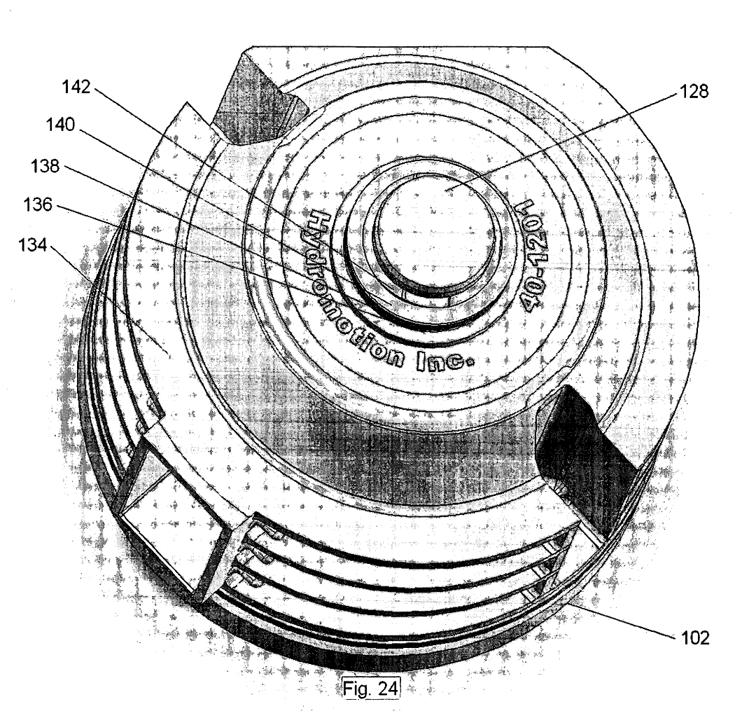

FIG. 18 illustrates top portion 128 disposed in contact with contact plate stack wave spring 126. The apertures 128b defined by top portion 128 are aligned with insulator tubes 110. Top portion 128 also defines a groove 128a, the purpose of which will be described below with respect to FIG. 24.

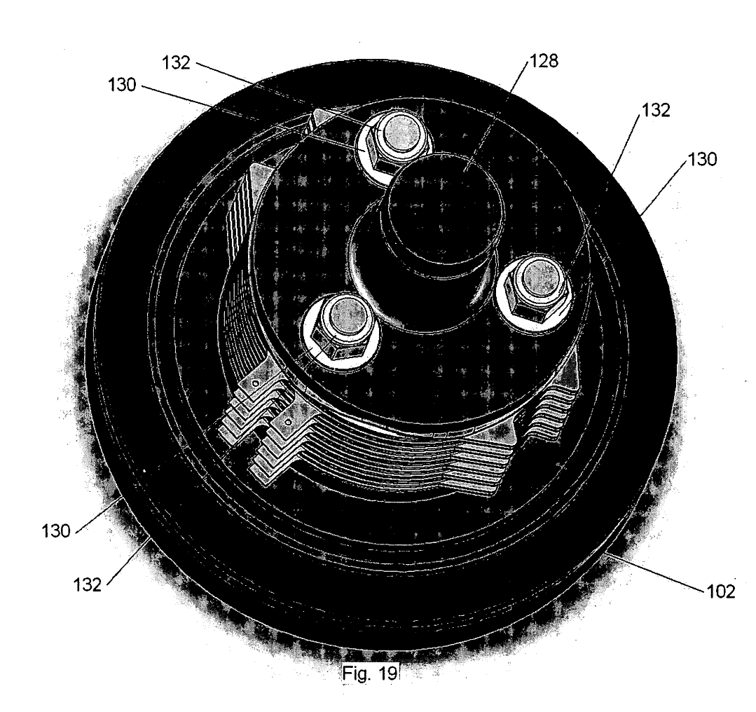

FIG. 19 illustrates washers 130 and nuts 132 engaged with studs 106. Nuts 132 are tightened to an appropriate torque (e.g., 35 inch-pounds) to provide the desired compressive force for contact stack 1600.

FIG. 20A illustrates housing 134 installed over contact stack 1600. Housing 134 defines a housing aperture 134a which facilitates access to conductive tabs 124a. Housing 134 also defines two (as illustrated) indented portions 134b. The function of indented portions 134b is described below.

FIG. 20B is a view of FIG. 20A with a portion of housing 134 and a portion of top portion 128 removed. As illustrated in FIG. 20B, each of indented portions 134b defines an interior surface 134c which is used in conjunction with anti-rotation tabs 124b to resist rotation of outer contact plates 124 and outer contact plate insulators 120 with respect to housing 134. Indented portions 134b are used to resist rotation of housing 134 during rotation of base 102.

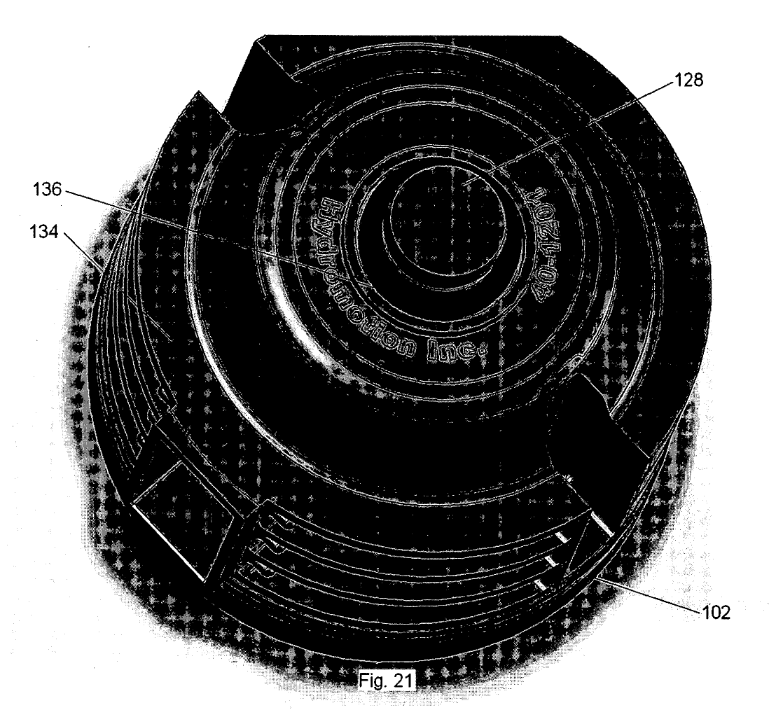

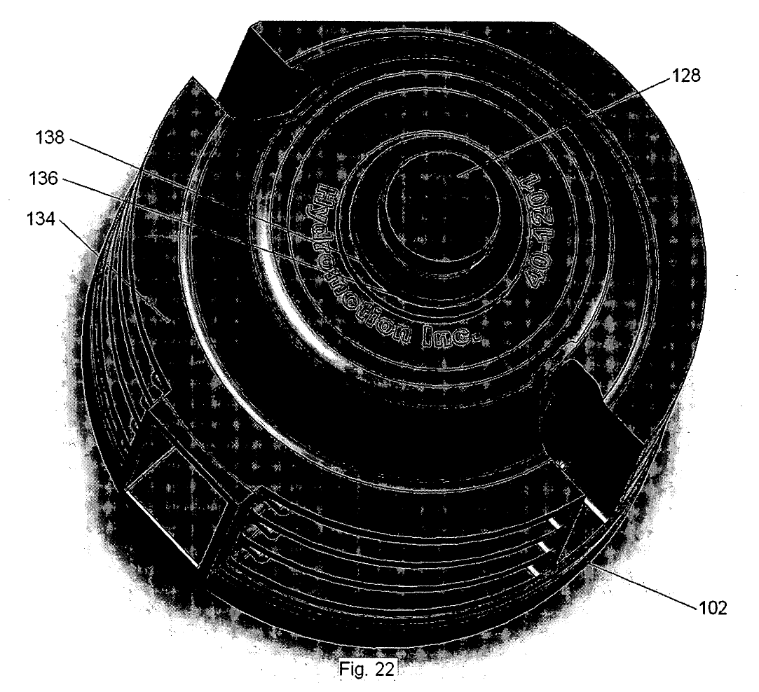

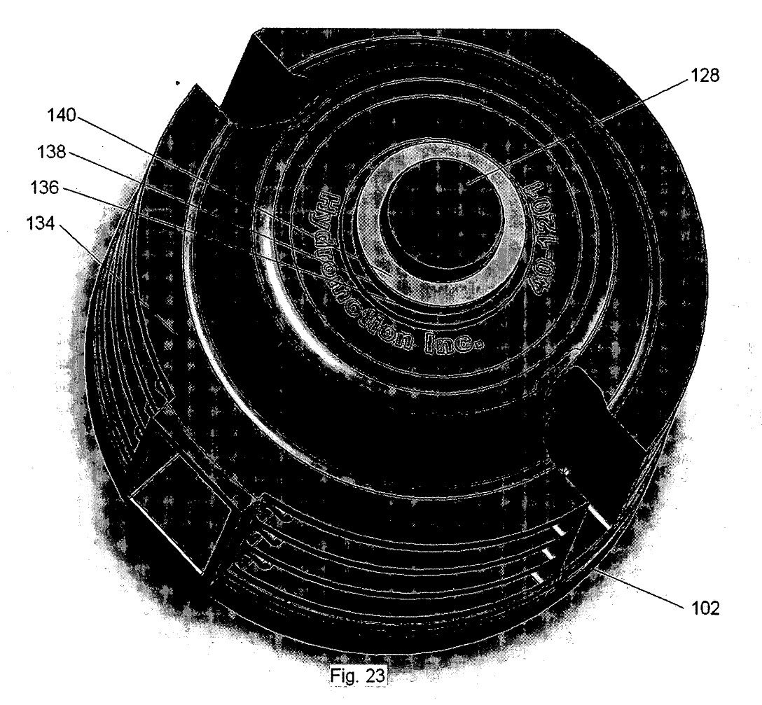

FIG. 21 illustrates top ring seal 136 disposed on a surface of housing 134. For example, top ring seal 136 may be formed of a rubber-based material such as nitrile. FIG. 22 illustrates top thrust bearing 138 disposed on top ring seal 136. FIG. 23 illustrates top thrust washer 140 disposed on top thrust bearing 138. For example, top thrust washer 140 may be formed of stainless steel. FIG. 24 illustrates top wave ring 142 disposed in groove 128a of top portion 128 (groove 128a is illustrated in FIG. 18). Top wave ring 142 applies a downward compressive force against top thrust washer 140, top thrust bearing 138, and top ring seal 136.

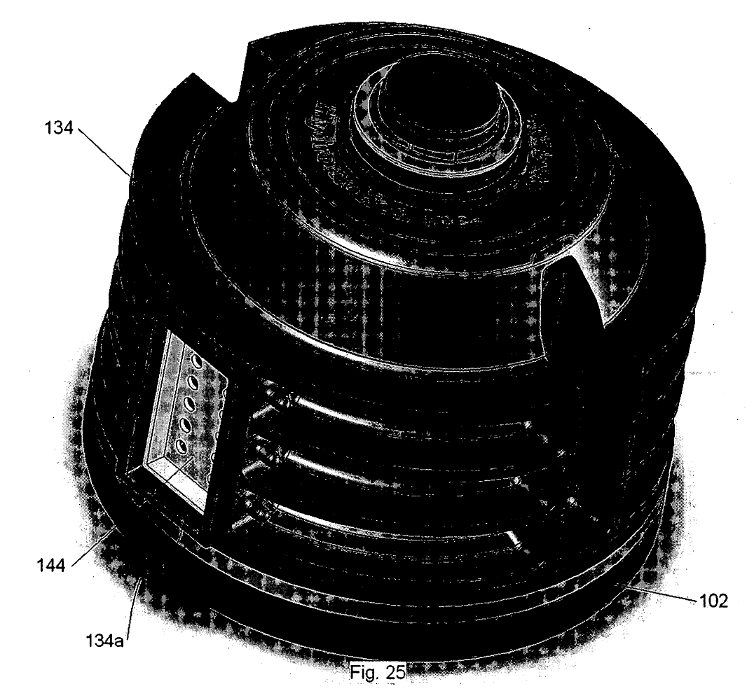

FIG. 25 illustrates housing wire spacer 144 installed in aperture 134a defined by housing 134. Housing wire spacer 144 defines a number of apertures for receiving conductors from one of a stationary structure or a rotating structure. Conductors that extend through the apertures defined by housing wire spacer 144 may be electrically connected to conductive tabs 124a (for example, through the use of female terminals or by soldering). Housing wire spacer 144 may be constructed of a number of materials including, for example, an insulative material such as molded plastic. If the conductors extending through the apertures defined by housing wire spacer 144 are properly insulated in the area passing through the apertures, however, a conductive material may be used to form housing wire spacer 144.

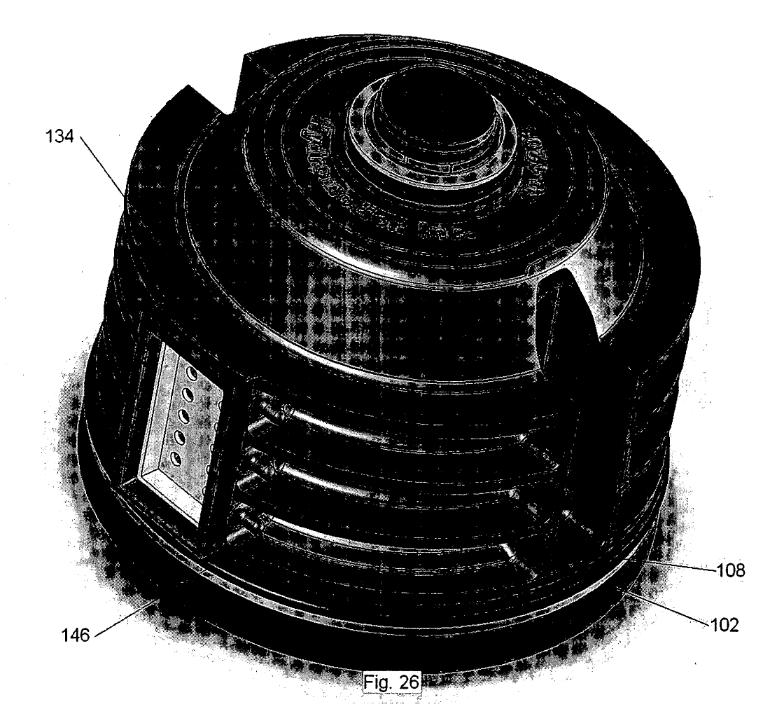

FIG. 26 illustrates base O-ring excluder seal 146. Base O-ring excluder seal 146 is provided as a seal between beveled edge 102c and the adjacent surface of base bearing 108.

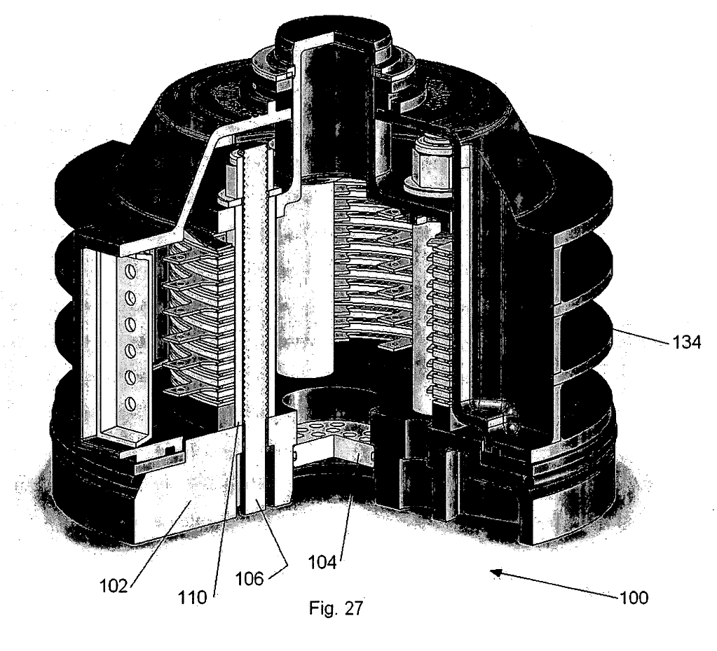

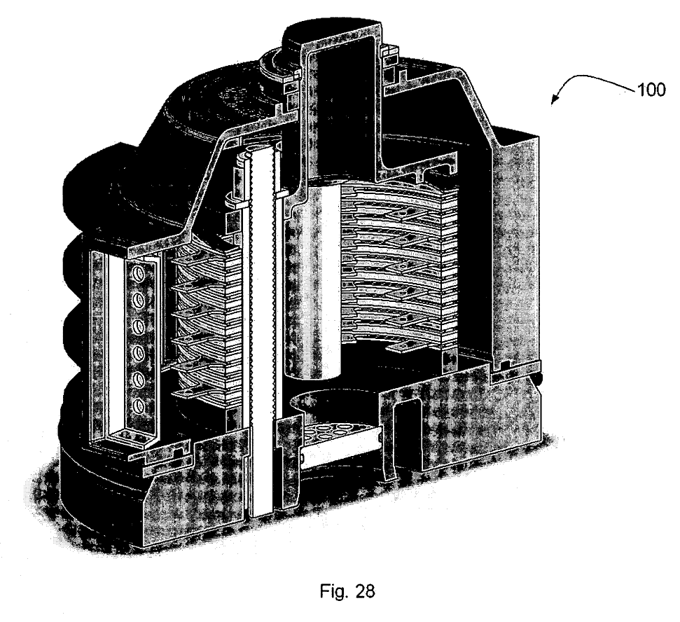

FIG. 27 is a partial cutaway perspective view of rotative electrical coupling 100 illustrating, for example, base 102, base wire spacer 104, stud 106, insulator tube 110, and housing 134. FIG. 28 is a cutaway view of rotative electrical coupling 100 illustrating various internal components.

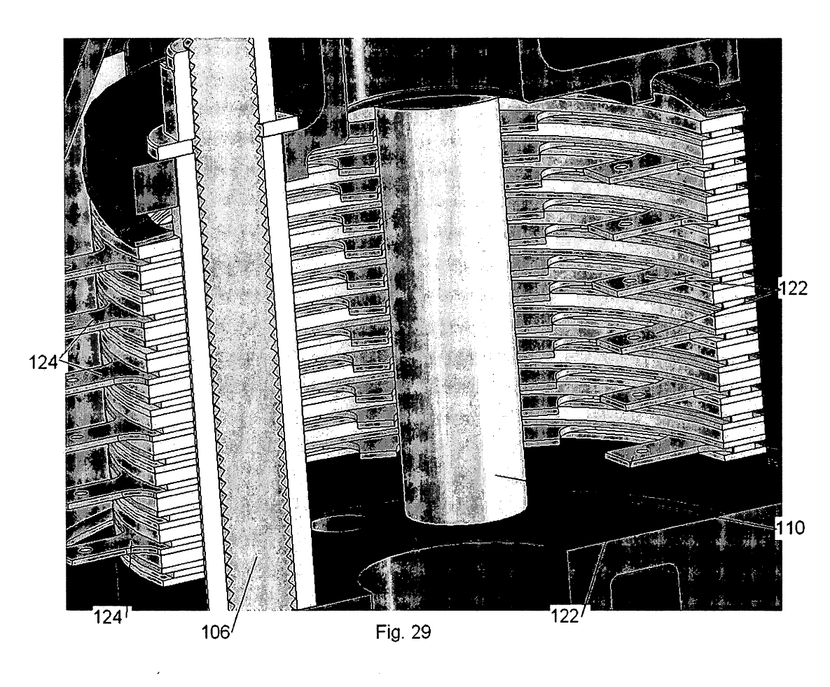

FIG. 29 is a detailed view of a portion of an internal region of rotative electrical coupling 100. FIG. 29 provides a detailed view of certain components, for example, stud 106, insulator tube 110, inner contact plates 122, and outer contact plates 124.

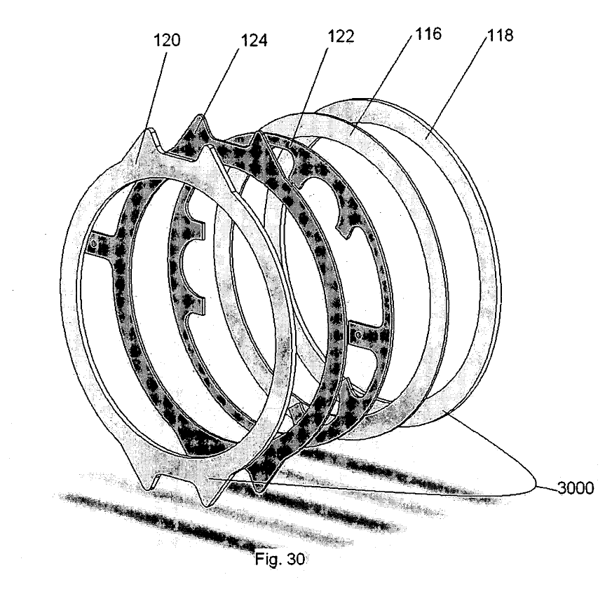

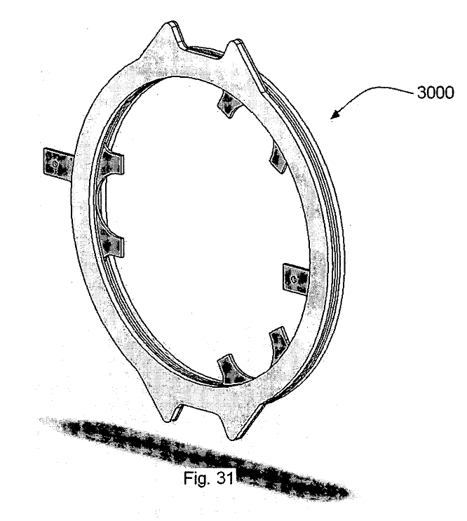

FIG. 30 is a exploded view of a set 3000 of contact plates and corresponding contact plate insulators. Set 3000 includes a pair of contact plates including inner contact plate 122 and outer contact plate 124. Outer contact plate insulator 120 is provided adjacent outer contact plate 124, and inner contact plate insulators 116 and 118 are provided adjacent inner contact plate 122. Contact plate insulators 116, 118, and 120 act as shims for adjusting the height and compressive tension of the contact stack assembly. Further, contact plate insulators 116, 118, and 120 electrically insulate each pair of contact plates (i.e., inner contact plate 122 and outer contact plate 124) from another pair, thereby providing discrete circuit paths through rotative electrical assembly 100. FIG. 31 is a non-exploded view of set 3000.

As described above by reference to the figures, certain embodiments of the present invention provide a multi-circuit rotary electric union using flat, dry lubricated outer contact plates 124 (e.g., steel rings) in constant electrical contact with flat inner contact plates 122 (e.g., brass rings). The contact plates are arranged in pairs and are used to distribute electrical current from a stationary structure to a rotating structure through a center of rotation defined by the stationary structure and the rotating structure.

Constant compression of the contact stack (e.g., contact stack 1600) is achieved, for example, via a wave spring (e.g., contact plate stack wave spring 126). In the exemplary embodiment of the present invention illustrated in the figures, contact plate stack wave spring 126 applies a compressive force through the cross sectional center of contact stack 1600 when nuts 132 (e.g., elastic stop nuts) on studs 106 are tightened, thereby compressing contact stack between base 102 and top portion 128.

As provided above, outer contact plates 124 define conductive tabs 124a configured to be coupled to a conductor extending through housing wire spacer 144 via, for example, a female terminal or soldering. Likewise, inner contact plates 122 define conductive tabs 122a configured to be coupled to a conductor extending through base wire spacer 104 via, for example, a female terminal or soldering. In certain exemplary embodiments of the present invention, rotative electrical coupling 100 is configured such that base 102 rotates independent of housing 134. As provided above, outer contact plates 124 move with housing 134 and inner contact plates 122 move with base 102, which allows continuous 360° rotation of rotative electrical coupling 100 while maintaining electrical interconnection between each of the pairs of inner contact plates 122 and outer contact plates 124.

According to an exemplary embodiment of the present invention, inner contact plate 122 and outer contact plate 124 are formed of dissimilar metals. Further, in certain embodiments, one of inner contact plate 122 and outer contact plate 124 is formed of a hard metal, and the other of inner contact plate 122 and outer contact plate 124 is formed of a soft metal. Hard metals are a group of materials characterized by high hardness and metallic properties such as, for example, steel. Often, hard metals are hard metallic materials (which may be considered brittle) combined with relatively soft yet tough metals (e.g., iron, cobalt, and nickel). Exemplary soft metals include brass, aluminum, copper, and zinc. As used in this document, the term “hard metal” and “soft metal” are intended to be “hard” or “soft” relative to one another.

“Galling” is a condition that may result when excessive friction exists between similar metals. Galling results in localized welding with subsequent splitting and a further roughening of the respective rubbing surfaces on one or both of the similar metals. By using dissimilar metals to form inner contact plates 122 and outer contact plates 124, particularly when one of the dissimilar metals is substantially harder than the other, the likelihood that galling will occur can be substantially reduced.

According to an exemplary embodiment of the present invention, inner contact plates 122 are formed of brass and outer contact plates 124 are formed of steel. Thus, the contact point between the plates is a soft brass material and a harder steel material. Often, the brass is able to pass some of its surface to the steel, further reducing friction and the potential of galling of the two materials.

The interface between inner contact plates 122 and outer contact plates 124 may be lubricated with a suitable dry lubricant, such as, for example, Industrial Ultra-Lite 3-36 dry film lubricant marketed by CRC Industries NZ Ltd. In addition to its lubricating properties, such a dry lubricant resists corrosion at the interface between inner contact plates 122 and outer contact plates 124.

A number of additional benefits over conventional devices are achieved through use of the rotative electrical coupling of the present invention. For example, because of the relatively large electrical contact area (i.e., the contact area between inner contact plate 122 and outer contact plate 124), electrical communication through the rotative electrical coupling results in reduced electrical noise and a reduced likelihood of “dead” spots such that the coupling is suitable for low-voltage data communication.

Further, the rotative electrical coupling of the present invention may require less maintenance than certain conventional devices. For example, the interface between inner contact plate 122 and outer contact plate 124 may be coated with a dry lubricant that does not require regular replacement or maintenance. Such a dry lubricant results in a more environmentally safe coupling because silicone oil lubricants (which tend to result in electrical couplings that leak) are not used. Further, the coupling may be “pre-wired” such that little or no internal wiring is completed by the end user.

In addition, the rotative electrical coupling of the present invention provides substantial cost benefits in comparison to conventional rotative couplings. For example, top portion 128, housing 134, and base 102 may be formed of a relatively inexpensive injection molded plastic as opposed to machine cast aluminum (which typically involves anodization). Further, fewer components may be used because of the molded plastic components. Further still, the dry lubricant used at the interface between inner contact plate 122 and outer contact plate 124 tends to be significantly less expensive than conventional silicone oil lubricants.

The coupling of the present invention also includes fewer components in comparison to conventional rotative couplings. For example, the use of molded plastic components results in a reduced number of components (e.g., fasteners). Further, by using a dry lubricant (as opposed to a silicone oil) a reduced number of components are used to seal the coupling (i.e., the coupling of the present invention may not be hermetically sealed). The reduced number of components also results in a more rapid and efficient assembly of the coupling.

The present invention is suitable for any application which requires electrical interconnection between a stationary component (e.g., a stationary structure, a stationary platform) and a rotating component (e.g., a rotating structure, a rotating platform) where the rotating component rotates with respect to the stationary component. Exemplary applications include mobile hydraulic equipment with a rotating table (e.g., cranes, aerial work platforms, manlifts, etc.) and rotating signs.

The electrical signals transmitted through the electrical coupling of the present invention vary in range and magnitude. Exemplary signals include power signals, control signals, analog communication signals, digital communication signals, and any other electrical signal. In certain applications where power signals and communication signals are transmitted through a single electrical coupling, interference may be avoided through the use of shielding, insulative materials, clearance between conductors, etc.

Although illustrated and described above with reference to certain specific embodiments, the present invention is nevertheless not intended to be limited to the details shown. Rather, various modifications may be made in the details within the scope and range of equivalents of the claims and without departing from the spirit of the invention. It is expressly intended, for example, that all ranges broadly recited in this document include within their scope all narrower ranges which fall within the broader ranges.

1. A rotative electrical coupling for providing electrical interconnection between a stationary component and a rotating component, the rotating component being rotative with respect to the stationary component, said rotative electrical coupling comprising:
a first conductive plate having a contact surface and configured to be in electrical contact with a conductor of the stationary component;
a second conductive plate having a contact surface and configured to be in electrical contact with a conductor of the rotating component; and
a dry lubricant between said first conductive plate contact surface and said second conductive plate contact surface;
said second conductive plate contact surface being in constant electrical contact with said first conductive plate contact surface, said second conductive plate rotating with respect to said first conductive plate during rotation of the rotating component with respect to the stationary component.

2. The rotative electrical coupling of claim 1 wherein said first conductive plate comprises a soft metal and said second conductive plate comprises a hard metal.

3. The rotative electrical coupling of claim 1 wherein said first conductive plate comprises brass and said second conductive plate comprises steel.

4. (canceled)

5. The rotative electrical coupling of claim 1 comprising a plurality of pairs of said first conductive plate and said second conductive plate, said pairs being insulated from one another such that each of said pairs is configured to carry a distinct electrical signal between the stationary component and the rotating component and wherein a dry lubricant is provided between the respective contact surfaces of each of said pairs.

6. The rotative electrical coupling of claim 1 further comprising a housing and a base, said first conductive plate and said second conductive plate being disposed substantially between said housing and said base.

7. The rotative electrical coupling of claim 6 wherein said housing and said base are formed of molded plastic.

8. The rotative electrical coupling of claim 6 wherein said base defines a base aperture for receiving a conductor configured to be coupled to one of said first conductive plate and said second conductive plate, and said housing defines a housing aperture for receiving another conductor configured to be coupled to the other of said first conductive plate and said second conductive plate.

9. The rotative electrical coupling of claim 6 wherein said first conductive plate defines at least one anti-rotation tab configured to resist rotation of said first conductive plate with respect to one of said base and said housing.

10. The rotative electrical coupling of claim 9 wherein said second conductive plate defines at least one additional anti-rotation tab configured to resist rotation of said second conductive plate with respect to the other of said base and said housing.

11. The rotative electrical coupling of claim 1 wherein each of said first conductive plate and said second conductive plate defines a respective conductive tab configured to be electrically coupled to at least one of the conductor of the rotating component or the conductor of the stationary component.

12. A rotative electrical coupling for providing electrical interconnection between a stationary component and a rotating component, the rotating component being rotative with respect to the stationary component, said rotative electrical coupling comprising:
a base;
a plurality of pairs of conductive plates, each of said pairs including a first conductive plate having a contact surface and configured to be in electrical contact with a conductor of the stationary component and a second conductive plate having a contact surface and configured to be in electrical contact with a conductor of the rotating component;
a dry lubricant between said first conductive plate contact surface and said second conductive plate contact surface, said second conductive plate contact surface being in constant electrical contact with said first conductive plate contact surface, said second conductive plate rotating with respect to said first conductive plate during rotation of the rotating component with respect to the stationary component;
a plurality of insulators, at least one of said insulators being provided between each of said pairs of conductive plates such that each of said pairs of conductive plates is insulated from other pairs and configured to carry a distinct electrical signal; and
a housing configured to be coupled to said base such that said plurality of pairs of conductive plates and said plurality of insulators are disposed substantially between said housing and said base.

13. The rotative electrical coupling of claim 12 wherein said first conductive plate comprises a soft metal and said second conductive plate comprises a hard metal.

14. The rotative electrical coupling of claim 12 wherein said first conductive plate comprises brass and said second conductive plate comprises steel.

15. (canceled)

16. The rotative electrical coupling of claim 12 wherein said housing and said base are formed of molded plastic.

17. The rotative electrical coupling of claim 21 wherein said base defines a base aperture for receiving a conductor configured to be coupled to one of said first conductive plate and said second conductive plate of one of said pairs, and said housing defines a housing aperture for receiving another conductor configured to be coupled to the other of said first conductive plate and said second conductive plate of said one of said pairs and wherein both the base aperture and the housing aperture are substantially sealed about the respective conductors.

18. The rotative electrical coupling of claim 12 wherein said first conductive plate defines at least one anti-rotation tab configured to resist rotation of said first conductive plate with respect to one of said base and said housing.

19. The rotative electrical coupling of claim 18 wherein said second conductive plate defines at least one additional anti-rotation tab configured to resist rotation of said second conductive plate with respect to the other of said base and said housing.

20. The rotative electrical coupling of claim 12 wherein each of said first conductive plate and said second conductive plate defines a respective conductive tab configured to be electrically coupled to at least one of the conductor of the rotating component or the conductor of the stationary component.

21. The rotative electrical coupling of claim 12 further comprising at least one seal positioned between the housing and the base to substantially seal an interior defined by the housing and the base.
